(19) United States
(12) Patent Application Publication
(10) Pub. No.: US 2009/0120179 A1
(43) Pub. Date: May 14, 2009

(54) Precipitation Weighing Gauge and a Method for Precipitation Measurement

(76) Inventors: Pauli Nylander, Helsinki (FI); Taisto Haavasoja, Helsinki (FI); Pekka Puura, Vantaa (FI); Samuli Raisanen, Vantaa (FI)

Correspondence Address: BIRCH STEWART KOLASCH & BIRCH, PO BOX 747, FALLS CHURCH, VA, 22040-0747, US

(21) Appl. No.: 11/991,540

(22) PCT Filed: Sep. 5, 2006
(86) PCT No.: PCT/FI2006/000296

§ 371 Date: Jun. 11, 2008

(51) Int. Cl. G01W 1/14

(52) U.S. Cl. 73/170.17

(57) ABSTRACT

The invention relates to a precipitation weighing gauge, comprising a frame (1), a load cell (2) mounted on the frame (1), a collector bucket (3) mounted on the load cell (2), either directly or using a separate weighing platform (18), a funnel element (5) adapted to rest on the collector bucket (3) during measurement, and a jacket (4) connected to the frame (1) and surrounding the collector bucket (3). According to the invention to the jacket (4) is mounted an orifice element (7) including a spraying device (8) for spraying liquid in order to melt ice or snow from the orifice (7), the funnel (5) or the collector bucket (3) surfaces.

A precipitation weighing gauge and a method for precipitation measurement

The present invention relates to a precipitation weighing gauge according to the preamble of Claim 1.

The invention also relates to a method for precipitation measurement.

Accurate measurement of precipitation has been a challenge, especially in climatic conditions where both liquid and solid precipitation (snow, sleet) occur. In principle weighing gauges are the most suitable point precipitation gauges for these conditions due to the fact that melting of snow is not required for the measurement.

However, conventional weighing precipitation gauges are impaired by a multitude of errors. These include the error sources common to all point precipitation gauges—wind, evaporation and wetting errors—which all tend to cause systematic deficits. In winter conditions instrumental errors related to accumulation of snow and ice on rim and funnel parts of the gauge, as well as complete filling of the gauge with snow may result in severe underestimation. These problems are only partially solved using antifreeze solution in the container and applying rim heating.

The present invention is intended to solve some defects of the state of the art disclosed above and for this purpose create an entirely new type of solution for precipitation weighing gauge and a measurement method thereof.

The invention is based on the fact that the funnel element is adapted to rest on the collector bucket during measurement.

According to one preferred embodiment of the invention both the collector bucket and the funnel element are completely inside the jacket and a necking is formed in the connection between the collector bucket and the funnel element.

According to a second preferred embodiment, to the jacket is mounted an orifice element including a spraying device for spraying liquid in order to melt ice or snow from the orifice, the funnel element or the collector bucket surfaces.

More specifically, the precipitation weighing gauge according to the invention is characterized by what is stated in the characterizing portion of claim 1.

The method according to the invention is, in turn, characterized by what is stated in the characterizing portion of claim 4.

Considerable advantages are gained with the aid of the invention.

The present invention provides higher accuracy and extended maintenance period, and thus lower life-cycle cost in all weather conditions.

Simple and robust mechanics, large collecting area, latest high-accuracy load cell technology and advanced measurement and heating control algorithms ensure high performance, both in liquid and solid precipitation and in all weather conditions.

The single point—type load cell is designed for direct mounting of the weighing platform (frame). Eliminating levers and flexures, this allows simple, robust and low cost mechanics.

The load cell 2 is insensitive to eccentric loading. Therefore, unlike some other types of weighing gauges, unsymmetrical distribution of snow in the collecting bucket (typical for winter conditions) does not introduce measurement errors.

Another error source which is eliminated by enhanced mechanics is the deficit caused by water and snow sticking on the inner surfaces of the gauge inlet funnel. In conventional designs this mass is not measured and eventually evaporates. As mentioned earlier, in the design according to the invention the funnel element is resting on the collector container. All water and snow on it's surface will be included in the measured mass.

In the following, the invention is examined with the aid of examples of applications according to the accompanying drawings.

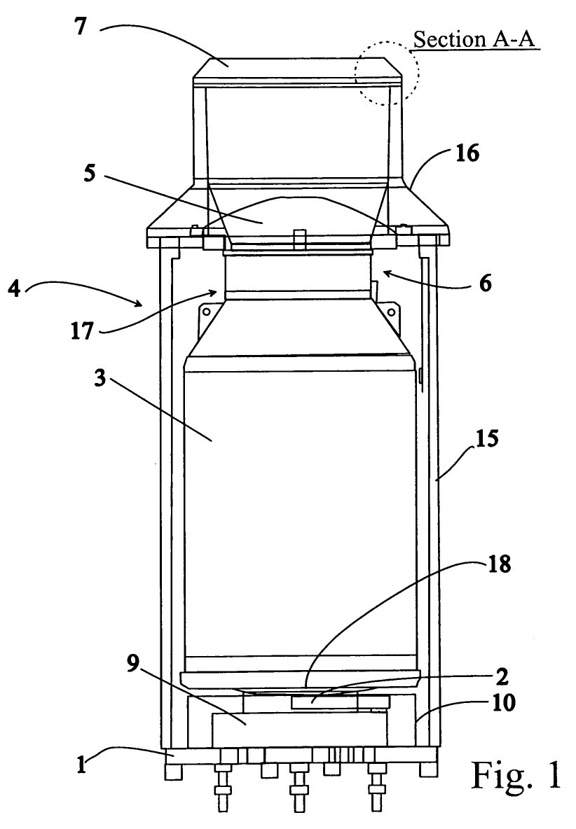

FIG. 1 shows as a side view one precipitation weighing gauge according to the invention.

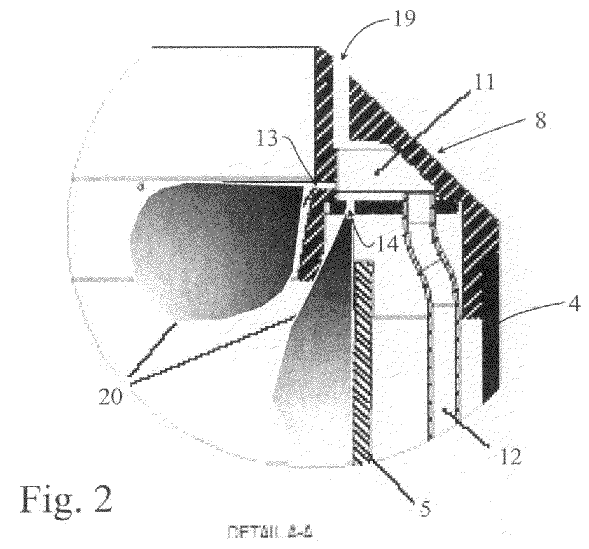

FIG. 2 shows section A-A of FIG. 2 in more detail.

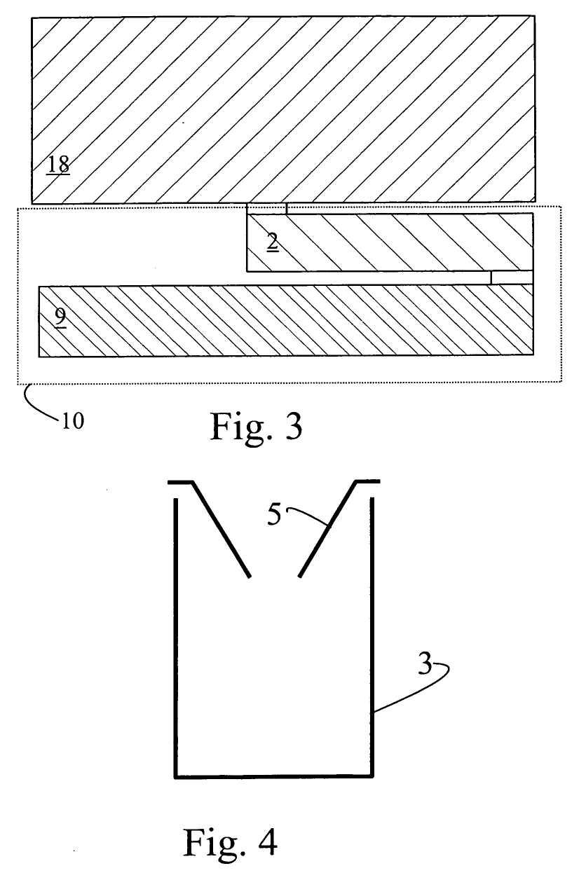

FIG. 3 the lower part of the precipitation weighing gauge of FIG. 1 in more detail.

FIG. 4 shows schematically a sectioned side view of another embodiment of the invention.

List of terms used in the following specification:
1 frame
2 load cell
3 collector bucket
4 jacket
5 funnel element
6 necking
7 orifice element
8 spraying device
9 electronics unit
10 replaceable unit
11 liquid chamber
12 liquid hose
13 middle nozzle
14 lower nozzle
15 lower part of the jacket
16 upper part of the jacket
17 measuring vessel
18 weighing platform
19 upper nozzle
20 jets formed by the nozzles

According to FIG. 1 the measurement apparatus comprises a solid frame 1 mounted directly on a foundation or on a pedestal with enough free space around it. A load cell 2 is positioned either directly or via an electronics unit 9 on the frame 1. The electronics unit 9 forms a totally rigid connection between the frame 1 and the load cell so it can be considered as a part of the frame 1 in the sense of the measurement. In other words the load cell 2 is supported by the frame either directly or indirectly via electronics unit 9. The weighing platform 18 is mounted on the load cell from it's midpoint. The collector bucket 3 is resting freely on the weighing platform 18. The connection between the frame 1, electronics unit 9 and the weighing platform 18 is in more detail described in connection with FIG. 3. A jacket 4 surrounding the collector bucket 3 is positioned on the frame 1. The jacket 4 comprises a lower part 15 fixedly mounted on the frame and an upper part 16 preferably removable from the lower part. In this embodiment the upper part 16 of the jacket 4 is hinged or pivoted to the lower part 15 of the jacket 4.

Inside the jacket 4, above the collector bucket 3 is positioned a funnel element 5 such that it rests during the measurement on the collector bucket 3. In this way any water, snow or ice attached to any surface of the funnel element 5 is included to the weighing process and will be considered as a part of the collected precipitation. Even though the funnel element 5 does not contact the jacket 4 during the measurement, the funnel element 5 is on the other hand preferably loosely coupled to the upper part 16 of the jacket 4 during opening operation such that any service operations for the collector bucket 3 can be performed easily. This loose connection can be performed by a narrowing in the lower end of the funnel element 5 such that the funnel element 5 rests on its cone shaped lower part on the inside of the upper part of the jacket 16. This narrowing together with a corresponding narrowing in the upper part of the collector bucket 3 form a necking 6 to the measuring vessel 17 serving also as an element for restricting evaporation and blowing out of dry snow by wind from the collector bucket 3.

According to FIG. 1 the upper part of the jacket 16 comprises in a preferred embodiment an orifice element 7 defining the collecting area. In this solution the collecting bucket 3 and the funnel element 5 are enclosed inside the jacket 4 formed by lower 15 and upper elements 16 and the orifice element 7 attached to the upper element 16. In the embodiment of FIG. 1 the measurement vessel 17 formed by the collecting bucket 3 and the funnel element 5 is completely inside the jacket 4, formed by the upper 16 and lower 15 parts and the orifice 7 element.

According to FIG. 2 a liquid hose 12 is positioned between the funnel element 5 and the jacket 4 in order to guide suitable liquid to the liquid chamber 11 inside the rim of the orifice element 7. The liquid can be e.g., glycol, ethanol, isopropyl alcohol or other suitable solvent. Along the circumference of the rim of the orifice element 7 there are one or more nozzles 13, 14 and 19 such that the liquid is distributed to the inner and outer surfaces of the orifice element 7 and the funnel element 5. The middle nozzles 13 are aligned preferably essentially horizontally and the upper and lower nozzles 14 and 15 essentially vertically. The middle 13, upper 19 and lower 14 nozzles can be replaced by a single narrow slot forming a circular nozzle. The jets formed by the nozzles are presented by reference number 20.

According to FIG. 3 the load cell 2 is connected between the electronics unit 9 and the weighing platform 18 such that one end of the load cell 2 is attached essentially to the center of the bottom of the weighing platform 18 and the opposite end of the load cell to the electronics unit 9.

Preferably the electronics unit 9 and the load cell 2 form a replaceable combination 10 for service purposes.

The load cell 2 is typically based on strain gauge technology.

The gauge according to the invention utilizes latest high-accuracy, single-point, temperature-compensated load cell technology.

Optional rim heating is recommended whenever solid precipitation measurement is needed. Heating prevents accumulation of snow and ice on the rim and collecting funnel. To prevent extraneous evaporation error caused by heating, as well as to minimize power consumption, the heating is controlled by the gauge software. The control algorithm is based on ambient temperature and precipitation status.

In the design special emphasis has been put on easy maintenance and extended service interval.

The hinged upper part (rim and collecting funnel) and detachable enclosure door allow smooth access for performing maintenance or adding antifreeze agent, as well as easy removal of the collector container.

The electronics unit 9, including the load cell 2 is field-removable. Replacement of the electronics is straightforward and quick causing minimal data loss, i.e. there is no need to transport the whole gauge to the laboratory for calibration. If needed, field calibration can be done using calibration weights.

In FIG. 4 is shown another embodiment of the invention, where the funnel element 5 is positioned at least partially inside the collector bucket 3 ands only the upper part of the funnel element 5 is above and leaning on the rim of the collector bucket 3.

1. A precipitation weighing gauge, comprising
a frame (1),
a load cell (2) mounted on the frame (1),
a collector bucket (3) mounted on the load cell (2), either directly or using a separate weighing platform (18),
a funnel element (5) adapted to rest on the collector bucket (3) during measurement, and
a jacket (4) connected to the frame (1) and surrounding the collector bucket (3),
characterized in that
to the jacket (4) is mounted an orifice element (7) including a spraying device (8) for spraying liquid in order to melt ice or snow from the orifice (7), the funnel (5) or the collector bucket (3) surfaces.

2. An apparatus according to claim 1, characterized in that both the collector bucket (3) and the funnel element (5) are completely inside the jacket (4).

3. An apparatus according to claim 1, characterized in that a necking (6) is formed in the connection between the collector bucket (3) and the funnel element (5).

4. A method for measuring precipitation, in which method
the precipitation is collected to a measuring vessel (17) comprising a collecting bucket (3) and a funnel element (5),
the complete measuring vessel (17) including the funnel element (5) is weighed.
characterized in that
in that the upper part of the measuring vessel (17) and/or the parts in its vicinity (7) are heated and/or
a suitable liquid is sprayed to the upper part of the measuring vessel (17) and/or to the parts in its vicinity (7).

5. An apparatus according to claim 2, characterized in that a necking (6) is formed in the connection between the collector bucket (3) and the funnel element (5).
